(19) United States
(12) Patent Application Publication
(10) Pub. No.: US 2005/0016313 A1
(43) Pub. Date: Jan. 27, 2005

(54) Manipulator

(76) Inventors: William C. Robertson, Houston, TX (US); Richard E. Shafer, Webster, TX (US)

Correspondence Address: DUANE, MORRIS, LLP, 3200 SOUTHWEST FREEWAY, Suite 3150, HOUSTON, TX, 77027, US

(21) Appl. No.: 10/868,105

(22) Filed: Jun. 15, 2004

Related U.S. Application Data
(60) Provisional application No. 60/478,790, filed on Jun. 16, 2003.

(51) Int. Cl. B25J 17/00

(52) U.S. Cl. 74/490.01

(57) ABSTRACT

An articulated manipulator is disclosed, comprising a first arm segment; a second arm segment; an elbow joint disposed intermediate the first arm segment and the second arm segment; and an arm drive sealingly disposed in a drive housing, the arm drive adapted to provide controllable motion of at least one of (i) the first arm segment and the second arm segment. The manipulator may further comprise an azimuth joint rotatably connected to the first arm segment and a dynamic seal disposed intermediate the first arm segment and the azimuth joint. The manipulator may be constructed using lightweight materials and use dynamic seals to afford protection in harsh environments. The manipulator may be constructed to have a total weight of between around twenty pounds to around forty pounds while achieving a reach of around forty inches with a payload capacity of around twenty five pounds. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### RELATED APPLICATIONS

The current application claims priority through U.S. Provisional Application 60/478,790, filed Jun. 16, 2003, for a Manipulator.

### FIELD OF THE INVENTION

The inventions are related to manipulators. More specifically, the inventions are related to manipulators which may be configured for either mobile or static use, including in harsh environments.

### BACKGROUND OF THE INVENTION

Manipulators are typically used to robotically manipulate objects, e.g. grasp an object and move it from one place to another. In certain embodiments, lightweight, rugged, portable manipulators are required to manipulate high payloads within a large work envelope. Prior art manipulators with large work envelopes, however, often weigh in excess of seventy pounds and offer a lift capacity of six pounds or less.

Further, most electric manipulators are suitable only for use in dry, indoor environments and are therefore not suitable for use in wet environments, dusty environments, or the like. This also limits use of these manipulators in mobile applications or environments which require wash downs after being exposed to contaminants.

### BRIEF DESCRIPTION OF THE DRAWINGS

The features, aspects, and advantages of the present invention will become more fully apparent from the following description, appended claims, and accompanying drawings in which:

FIG. 1 is a view in partial perspective of an exemplary embodiment;

FIG. 2 is a view in partial perspective with cutaway of an exemplary embodiment showing an interior view without outer housings;

FIG. 3 is a second view in partial perspective with cutaway of an exemplary embodiment showing an interior view without outer housings; and

FIG. 4 is cutaway view of a detail of an exemplary wrist pitch motor assembly;

### DETAILED DESCRIPTION OF AN EXEMPLARY EMBODIMENT

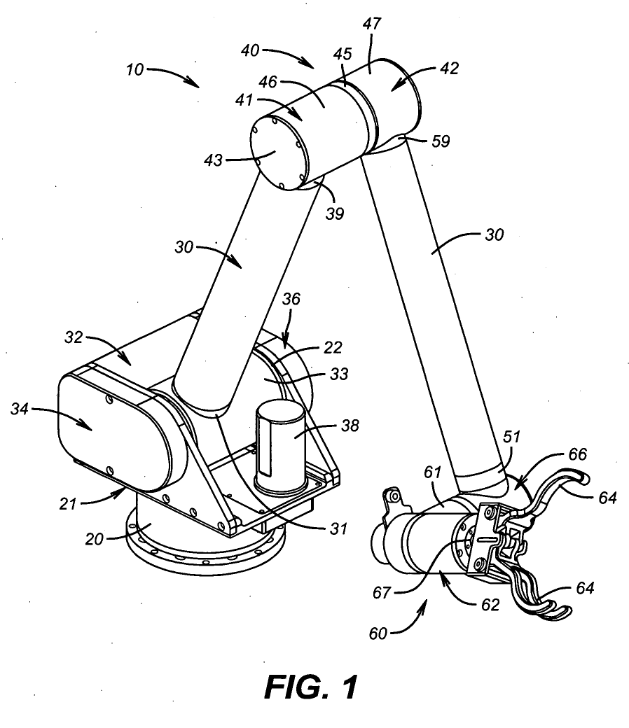

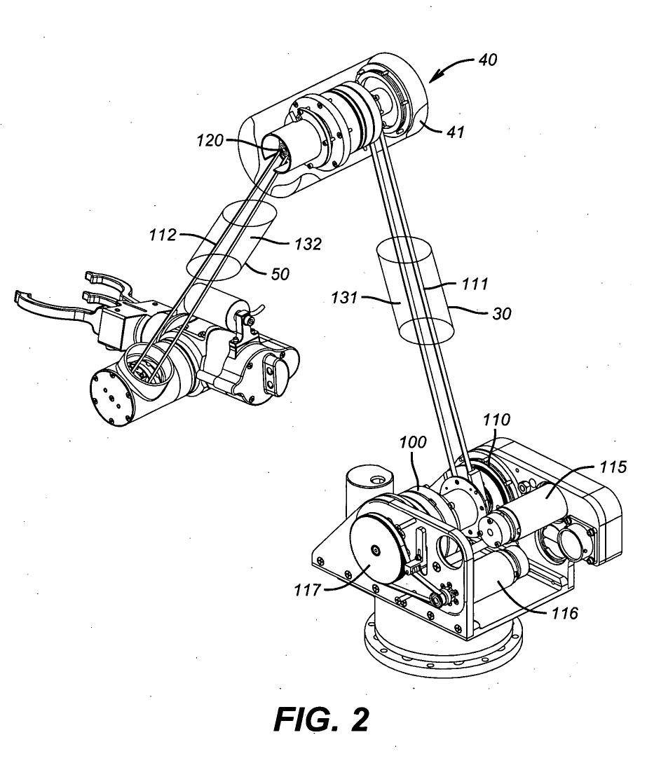

Referring now to FIG. 1, in a preferred embodiment articulated manipulator 10 comprises first arm segment 30, second arm segment 50, elbow joint 40 disposed intermediate first arm segment 30 and second arm segment 50, and arm drive 100 (FIG. 2) sealingly disposed in at least one of housings 32,34,36. In certain embodiments, azimuth joint 20 may be rotatably connected to first arm segment 30 and second dynamic seal 21 may be disposed intermediate the first arm segment 30 and azimuth joint 20. Dynamic seals, e.g. 21, 22, and 45, are preferably disposed where there is relative motion, e.g. between azimuth joint 20 and housings 32 and 36 and/or between segments 46,47 of elbow housing 40. In a preferred embodiment dynamic seals 21, 22, and 45 comprise an energized lip seal as opposed to O-rings or the like. Use of such seals helps exclude foreign matter from a drive train and/or electronics.

In a preferred embodiment, elbow joint 40 is adapted to provide second arm segment 50 with a range of motion of up to 360° in a single plane relative to first arm segment 30. Accordingly, elbow joint housing 41 may comprise two or more segments 46, 47. Dynamic seal 45 may be disposed intermediate segments 46 and 47. Dynamic seal 22 may be disposed intermediate first arm segment 30 and second arm segment 50 at elbow joint 40.

Housings 32, 34, 36 may be sealingly disposed proximate first arm segment 30, e.g. intermediate first arm segment 30 and azimuth joint 20.

Gripper 60 may be moveably connected to an end of second arm segment 50, e.g. end 51 disposed distally from elbow joint 40. Gripper 60 may further comprise pitch joint 66 by which gripper 60 is connected to second arm segment 50. One or more fingers 64 may be present at an end of gripper 60. In these configurations, wrist roll drive hub 67 may be movably connected to pitch joint 66 and finger 64. Wrist roll joint 62 may further be disposed intermediate pitch joint 66 and wrist roll drive hub 67.

Gripper 60 may be adapted to be driven by a CO₂ pressure cartridge, a pneumatic actuator, an electric actuator, a hydraulic actuator, or the like, or a combination thereof, these being operatively coupled to gripper 60. Pneumatic actuators may comprise a pneumatic cylinder integrated into wrist roll drive hub 67. Similarly, electric actuators may comprise an electric motor integrated into wrist roll drive hub 67.

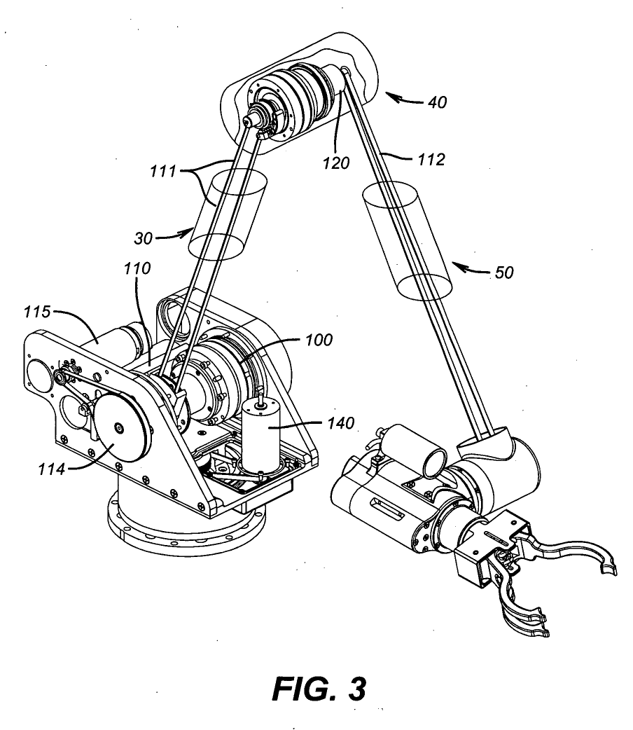

Referring additionally to FIG. 2 and FIG. 3, first arm segment 30 may be adapted to provide sealed passageway 131 through which motion transmission 111 may be disposed. Motion transmission 111 may be a belt or a driveshaft or the like, or a combination thereof.

Second arm segment 50 may be adapted to provide sealed passageway 132 through which motion transmission 112 may be disposed. Motion transmission 112 may also be a belt or a driveshaft or the like, or a combination thereof.

Arm drive 100 is adapted to provide controllable motion of at least one of first arm segment 30, second arm segment 50, or a combination thereof. Arm drive 100 may comprise one or more arm drives 100, e.g. one or more electric motors, hydraulic motors, pneumatic motors, or the like, or a combination thereof. Additionally, arm drive 100 is operatively in communication with at least one motion transmission, e.g. motion transmission 111.

Elbow transmission 120 may further be disposed in elbow joint 40, e.g. within elbow joint housing 41. In certain embodiments, elbow transmission 120 may comprise one or more reduction gears to adjust power transmitted from an incoming power source, e.g. from motion transmission 111, before transmitting the power to a subsequent power source, e.g. motion transmission 112. Each elbow joint 40 may comprise one or more elbow transmissions 120.

Azimuth joint drive motor 140 (FIG. 3) may be present and adapted to move first arm segment 30 relative to azimuth joint 20 in a predetermined plane. Azimuth joint drive motor 140 may comprise one or more electric motors, hydraulic motors, pneumatic motors, or the like, or a combination thereof. In certain embodiments, azimuth joint drive motor 140 further comprises a plurality of azimuth joint drive motors 140, each azimuth joint drive motor 140 being adapted to move azimuth joint 20 in a different plane.

Housing 34 may be an elbow pitch drive transmission housing 34 adapted to house a elbow pitch drive transmission 117, elbow pitch drive housing 32 adapted to house elbow pitch drive 115, and shoulder pitch drive transmission housing 36 may be adapted to house shoulder pitch drive transmission 114. Shoulder pitch drive transmission 114 will be operatively in communication with shoulder pitch drive 116.

Elbow pitch drive motor 115 may be present and sealingly housed proximate elbow pitch drive housing 32. Elbow pitch drive motor 115 may be adapted to move second arm segment 50 relative to a central axis of second arm segment 50.

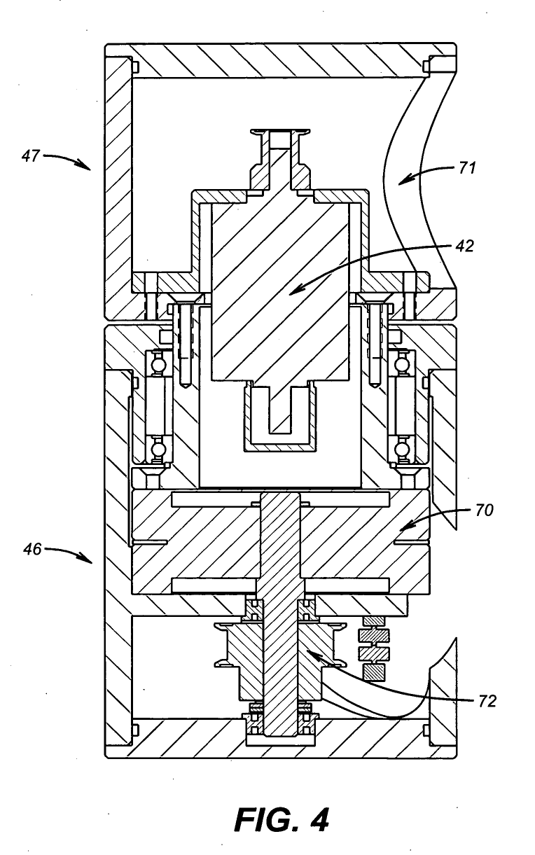

Referring additionally to FIG. 4, in an embodiment, wrist pitch motor 42 may be disposed proximate elbow joint 40, e.g. in segment 47, and comprise a high efficiency coreless electric motor. Harmonic drive 70 may be disposed in the same or another portion of elbow joint 40, e.g. segment 46, and be coupled to a portion of elbow joint 40, e.g. segment 47. Elbow harmonic drive 70 may be operatively in communication with a power transmission, e.g. drive pulley 72. Attachment 71 may be attached to or otherwise part of second arm segment 50.

Manipulator 10 may be used in mobile applications. Accordingly, manipulator 10 may be constructed using a light weight material and designed with lift capacity-to-weight ratio suited for mobile applications. Additionally, all or one or more components, e.g. shoulder pitch motor housing 32, elbow drive transmission housing 34, and/or shoulder pitch drive transmission housing 36, may comprise an alloy such as an aluminum or titanium alloy or the like. In this manner, manipulator 10 may be constructed to have a total weight of between around twenty pounds to around forty pounds while achieving a reach of around forty inches with a payload capacity of around twenty five pounds. In a preferred embodiment, first arm segment 30, second arm segment 50, and elbow joint 40 are scalable, e.g. lengths of first arm segment 30 and second arm segment 50 may changed independently.

Manipulator 10 may be suited to harsh environments by further dynamically and statically sealing all points of intrusion, e.g. to counter liquid and particulate intrusion. Drive motors, e.g. arm drive 100 and/or wrist pitch motor 42, are typically low power consumption, efficient electric motors. Electric motors such as MICROMO™ coreless DC micromotors manufactured by Faulhaber, MicroMo Electronics, Inc. of Clearwater, Fla. and MAXON™ coreless DC motors manufactured by Maxon Precision Motors, Inc. of Sachseln, Switzerland have been found to be suitable for such use.

Continuous roll capability may be present as configured to yields increased operability. Additionally, gripper 60 may be a modular end-effector assembly what may be easily reconfigured for alternate applications.

In the operation of an exemplary embodiment, manipulator (10) may be controlled by a variety of techniques as are well known in the art, e.g. simple open loop rate control, closed loop joint control, coordinated Cartesian controls, or the like, or combinations thereof.

It will be understood that various changes in the details, materials, and arrangements of the parts which have been described and illustrated above in order to explain the nature of this invention may be made by those skilled in the art without departing from the principle and scope of the invention as recited in the following claims.

1. An articulated manipulator, comprising:
a. a first arm segment;
b. a second arm segment;
c. an elbow joint disposed intermediate the first arm segment and the second arm segment, the elbow joint further comprising:
i. a first housing sealingly disposed proximate the first arm segment; and
ii. a first dynamic seal disposed intermediate the first arm segment and the second arm segment proximate the elbow joint; and
d. an arm drive sealingly disposed in a drive housing, the arm drive adapted to provide controllable motion of at least one of (i) the first arm segment and the second arm segment.

2. The articulated manipulator of claim 1, wherein the first arm segment is adapted to provide a sealed passageway through which a motion transmission may be disposed, the motion transmission operatively in communication with the arm drive.

3. The articulated manipulator of claim 2, wherein the motion transmission is at least one of (i) a belt or (ii) a driveshaft.

4. The articulated manipulator of claim 1, wherein the elbow joint is adapted to provide the second arm segment a range of motion of up to 360° in a single plane relative to the first arm segment.

5. The articulated manipulator of claim 1, wherein the drive housing further comprises:
a. an elbow pitch drive transmission housing adapted to house an elbow pitch drive transmission;
b. a elbow pitch drive housing adapted to house a elbow pitch drive; and
c. a shoulder pitch drive transmission housing adapted to house a shoulder pitch drive transmission, the shoulder pitch drive transmission operatively in communication with the shoulder pitch drive.

6. The articulated manipulator of claim 5, wherein elbow pitch drive motor is sealingly housed proximate the elbow pitch drive housing and adapted to move second arm segment relative to a central axis of the second arm segment.

7. The articulated manipulator of claim 6, further comprising a wrist pitch motor, further comprising:
a. a high efficiency coreless electric motor; and
b. a harmonic drive coupled to the high efficiency coreless electric motor.

8. The articulated manipulator of claim 1, further comprising:
a. an azimuth joint rotatably connected to the first arm segment; and
b. a second dynamic seal disposed intermediate the first arm segment and the azimuth joint.

9. The articulated manipulator of claim 8, further comprising an azimuth joint drive motor adapted to move the azimuth joint relative to the first arm segment in a predetermined plane.

10. The articulated manipulator of claim 1, further comprising a gripper moveably connected to the second arm segment distally from the elbow joint.

11. The articulated manipulator of claim 9 further comprising an pitch joint wherein the gripper is connected to the second arm segment at the pitch joint.

12. The articulated manipulator of claim 10 further comprising:
a. a finger;
b. a wrist roll drive hub movably connected to the pitch joint and the finger; and
c. a wrist roll joint disposed intermediate the pitch joint and the wrist roll drive hub.

13. The articulated manipulator of claim 10 wherein the gripper is adapted to be driven by at least one of (i) a CO₂ pressure cartridge, (ii) a pneumatic actuator operatively coupled to the gripper, (iii) an electric actuator operatively coupled to the gripper, or (iv) a hydraulic actuator operatively coupled to the gripper.

14. The articulated manipulator of claim 13 wherein the pneumatic actuator comprises a pneumatic cylinder integrated into the wrist roll drive hub.

15. The articulated manipulator of claim 13 wherein the electric actuator comprises an electric motor integrated into the wrist roll drive hub.

16. The articulated manipulator of claim 1, wherein the first arm segment, the second arm segment, and the elbow joint are scalable.

17. The articulated manipulator of claim 1, wherein the manipulator further comprises a total weight of between around twenty pounds to around forty pounds and at least one of (i) a reach of around forty inches or (ii) a payload capacity of around twenty five pounds.
